(19) United States
(12) Patent Application Publication
(10) Pub. No.: US 2022/0300953 A1
(43) Pub. Date: Sep. 22, 2022

(54) AUDITING DIGITAL CURRENCY TRANSACTIONS

(71) Applicant: Algorand, Inc., Boston, MA (US)

(72) Inventors: Silvio Micali, Brookline, MA (US); Naveed Ihsanullah, North Andover, MA (US)

(21) Appl. No.: 17/616,097

(22) PCT Filed: Jun. 4, 2020
(86) PCT No.: PCT/US20/36211

§ 371 Date: Dec. 2, 2021

Related U.S. Application Data
(60) Provisional application No. 62/856,847, filed on Jun. 4, 2019.

(51) Int. Cl. G06Q 20/36; G06Q 20/40; G06Q 20/38

(52) U.S. Cl. CPC G06Q 20/3678; G06Q 20/3674; G06Q 20/401; G06Q 20/389

(57) ABSTRACT

Among other things, a method performed by a certification authority includes receiving a request from a first entity for the first entity to conduct cryptocurrency transactions. The request includes information identifying the first entity and a public key of the first entity. A digital signature of the public key of the first entity is generated using an encryption key of the certification authority. A certification associated with the first entity is stored. The certification includes the digital signature and the public key of the first entity.

### CROSS-REFERENCE TO RELATED APPLICATION

This application claims the benefit of U.S. Provisional Application 62/856,847, filed on Jun. 4, 2019, which is incorporated herein by reference in its entirety.

### TECHNICAL FIELD

This description relates generally to auditing digital currency transactions.

### BACKGROUND

A public ledger is a tamperproof sequence of data that can be read and augmented. Shared public ledgers can revolutionize the way a modern society operates. Traditional transactions—such as payments, asset transfers, and titling—can be secured in an order in which they occur. New transactions—such as cryptocurrencies and smart contracts can be enabled. Corruption can be reduced, intermediaries removed, and a new paradigm for trust can be ushered in.

### SUMMARY

Methods, systems, and apparatus for auditing digital currency transactions are disclosed. Among other things, a method performed by a certification authority includes receiving a request from a first entity for the first entity to conduct cryptocurrency transactions. The request includes information identifying the first entity and a public key of the first entity. A digital signature of the public key of the first entity is generated using an encryption key of the certification authority. A certification associated with the first entity is stored. The certification includes the digital signature and the public key of the first entity.

### BRIEF DESCRIPTION OF THE DRAWINGS

FIG. 1 is a block diagram illustrating an architecture for auditing digital currency transactions in accordance with one or more embodiments.

FIG. 2 is a flowchart illustrating a process for auditing digital currency transactions in accordance with one or more embodiments.

FIG. 3 is a flowchart illustrating a process for auditing digital currency transactions in accordance with one or more embodiments.

FIG. 4 is a flowchart illustrating a process for auditing digital currency transactions in accordance with one or more embodiments.

FIG. 5 is a flowchart illustrating a process for auditing digital currency transactions in accordance with one or more embodiments.

FIG. 6 illustrates a table describing what an end-user receives for each tier of key, in accordance with one or more embodiments.

FIG. 7 illustrates an example machine.

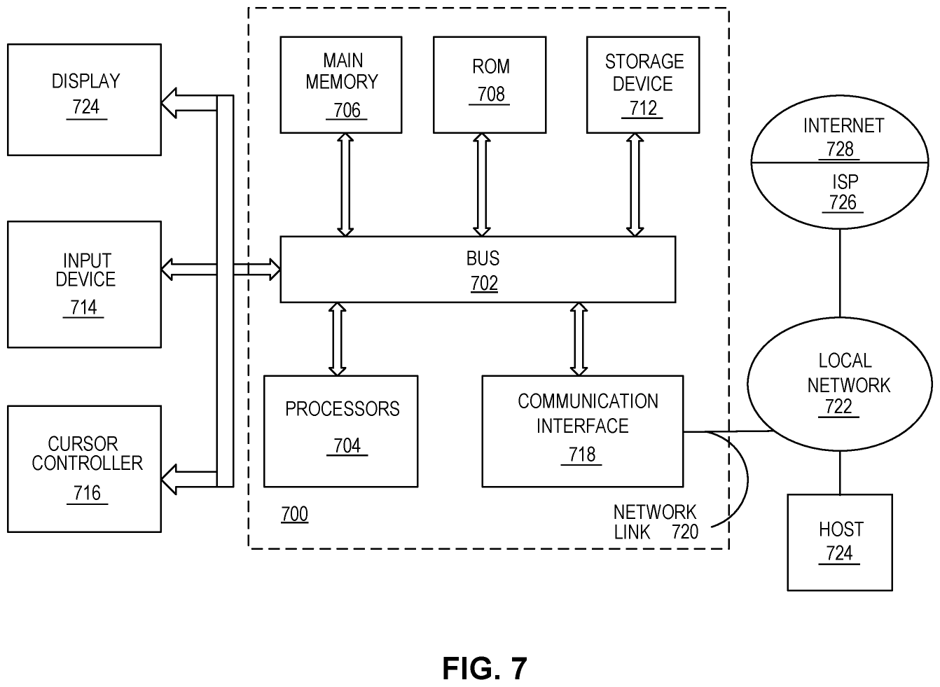

### DETAILED DESCRIPTION

In the following description, for the purposes of explanation, numerous specific details are set forth in order to provide a thorough understanding of the disclosed embodiments. It will be apparent, however, that the embodiments may be practiced without these specific details.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description.

General Overview

Digital currencies implemented via a blockchain allow for transaction transparency. In addition, blockchain protocols, such as the Algorand protocol, can increase the efficiency of transactions. For example, buying goods and services using the Algorand protocol can be nearly instantaneous. Moreover, using the Algorand protocol, the cost of processing a transaction is typically low. However, blockchain-based currencies can pose challenges. First, the relative anonymity of a digital currency may raise concerns from a governmental point of view. Digital currency is associated to public keys and can be transferred from a first public key to a second public key typically via a digital signature relative to the first public key. Such a signature is difficult to forge without knowledge of the secret key corresponding to the first public key. Thus, without knowing who owns a given public key, an auditing or regulatory authority may not know who is transacting with that given public key. Without additional protections in place, money laundering and other illegal activities may occur. Furthermore, traditional electronic payment provide for transaction reversal under proper conditions. Without additional protection in place such a reversal is not possible in a blockchain. Second, should an entity or user lose its secret signing key, it would de facto lose all money associated with its public key. Third, an illegitimate transaction or a transaction erroneously posted in a block of a blockchain cannot be reversed at all, or without disrupting the entire blockchain.

The embodiments disclosed herein include methods, apparatus, and systems for protecting a state-sponsored digital currency from the three problems described above. Among other benefits and advantages, the embodiments described herein a certification mechanism is provided for users in the system to register their keys and identities with authorized banking institutions (ABIs), and all transactions occur only between certified users. In some embodiments, the ABIs enable a government agency to retrieve user identities under specific legal requests. In other embodiments, ABIs enable the agency (and only the agency) to be automatically aware of the users' identities, so as to directly and continuously monitor all transactions for legality. In addition, a more nuanced balance is provided between the rights to privacy of individual citizens and those of the government serving them.

Digital Currency Auditing System

The embodiments described herein involve interactions performed between the following entities. A state monetary authority (SMA) refers to an entity empowered by a government to issue fiat and digital currencies. An SMA has the ability to contract and inflate the monetary supply as needed. An authorized banking institution (ABI) refers to a bank registered by an SMA. An ABI is empowered to collect user-identifying information from the users it has registered and certify that an account in a blockchain belongs to a registered user. ABIs may also refuse to certify the public key of an illegitimate user. A registered user (RU) refers to a user of the system who has registered its account or key with an ABI, and thus provided the ABI with its identifying information as well as proof of its desire to register a given key as its own. Only transactions between certified accounts will be validated and accepted. A sovereign digital currency (SDC) refers to a digital currency issued by an SMA with no protections against transactions between unknown or unidentified users. An anti-money-laundering sovereign digital currency (AMLSDC) refers to a digital currency issued by an SMA on a blockchain, such as the Algorand blockchain, that can only be transacted by RU accounts that have been certified by ABIs. The certification provided by the embodiments described herein indicates that user information has been properly collected for the RU accounts.

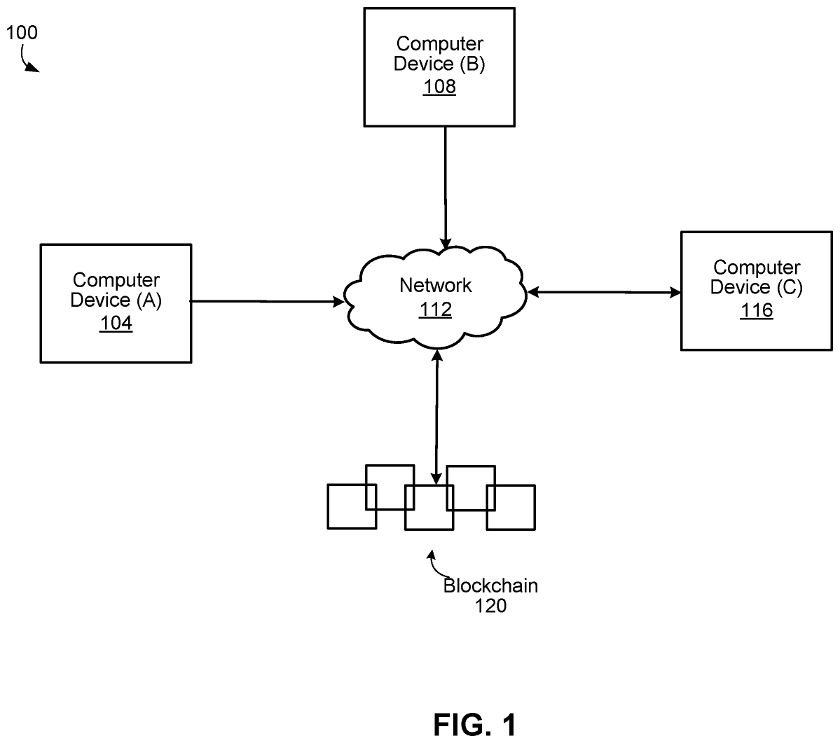

FIG. 1 is a block diagram illustrating an architecture for auditing digital currency transactions in accordance with one or more embodiments. In some embodiments, anti-money-laundering (AML) compliant tokens are used. For example, consider a scenario in which entities A, B, C, and D are users wishing to transact with AML tokens. Bank One refers to an ABI having authority over AML token certification. Bank Two refers to an ABI also having authority over AML token certification. PKᵤ refers to a certified public key for user u. The certified public key is an Algorand PK that is signed by an ABI after the user u submits its request for access to AML tokens along with its real-world identification.

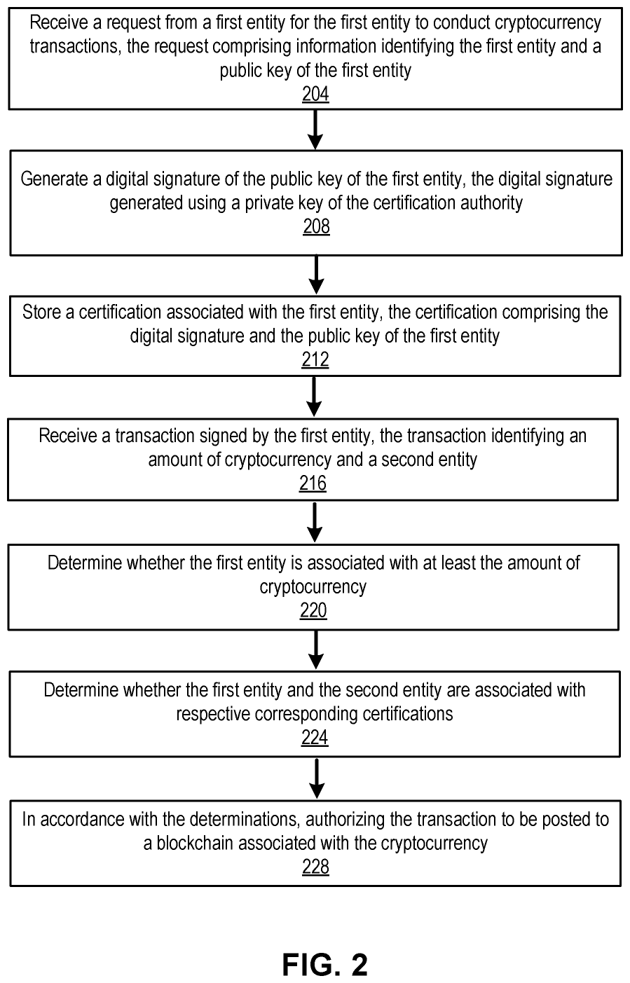

FIG. 2 is a flowchart illustrating a process for auditing digital currency transactions in accordance with one or more embodiments. In some embodiments, the process of FIG. 2 is performed by a certification authority for conducting a transaction between two entities. Other entities perform some or all of the steps of the process in other embodiments. Likewise, embodiments may include different and/or additional steps, or perform the steps in different orders. The certification authority can be any entity capable of carrying out these steps, and is typically an entity with a known identity and trusted by at least some users of the particular cryptocurrency. For example, the certification authority may be a bank or may be associated with a bank.

A computer device (e.g., of the certification authority) receives 204 a request from a first entity (e.g., “A” as described below) for the first entity to conduct cryptocurrency transactions. The request includes information identifying the first entity and a public key of the first entity. The certification authority generates 208 a digital signature of the public key of the first entity. The digital signature generated using an encryption key (e.g., private key) of the certification authority, e.g. using a digital signature algorithm.

The certification authority stores 212 a certification associated with the first entity. The certification includes the digital signature and the public key of the first entity.

The certification authority receives 216 a transaction signed by the first entity. For example, the transaction includes a signature that can be verified using the public key of the first entity. The transaction identifies an amount of cryptocurrency and a second entity (e.g., “B,” as described below).

The certification authority determines 220 whether the first entity is associated with at least the amount of cryptocurrency, though in some implementations, this step is optional. The certification authority determines 224 whether the first entity and the second entity are associated with respective corresponding certifications. If they are, in accordance with the determinations, the certification authority authorizes 228 the transaction to be posted to a blockchain associated with the cryptocurrency.

In some examples, the certification authority receives a request to authorize a transaction designated to be posted to a blockchain. (By “posted to a blockchain,” we mean included in a block of the blockchain that is accepted by nodes participating in the blockchain, such that the posted transaction becomes part of the blockchain.) For example, nodes associated with the blockchain and capable of receiving transactions to be posted can provide the transaction to the certification authority to confirm that the entities associated with the transaction are certified to conduct transactions. As another implementation, the certification authority may only be queried based on the identities of the entities associated with the transaction, such that the certification authority can confirm whether those entities are certified; in this implementation, the certification authority need not be provided with the transaction itself, and may be an alternative to the receives 216 step described above. The variations described in this paragraph are also applicable to some of the techniques described below.

The registration process for user A (computer device 104) is as follows. User A requests Bank One to transact with AML, tokens for PK_{A} after agreeing to all terms and conditions. Bank One securely stores A's request for AML token access. User A submits its identification to Bank One. Bank One accepts user A for AML token access. Bank One retains user A's identifying information securely. Bank One signs user A's public key as being certified for transacting in AML tokens. Here, SIG_{BankOne}(PK_{A}) refers to the certified public key PK′_{A}. A similar process is used for user B (computer device 108) to register itself. User B registers its public key with Bank Two. Here, SIG_{BankTwo}(PK_{B}) refers to the certified public key PK′_{B}. The different entities shown in FIG. 1 communicate over the network 112.

The registration process attempted by user C (computer device 116) is as follows. User C attempts to register. User C requests access from Bank Two to transact with AML tokens for public key PK_{C} after agreeing to all terms and conditions. Bank Two securely stores user C's request for accessing AML tokens. User C submits its identification to Bank Two. However, Bank Two rejects user C for AML token access because user C does not qualify. No certified public key PK′_{C} is produced. Further, consider a scenario in which user D bypasses registration. The user D bypasses registration with all the ABIs. Therefore, no certified public key PK′_{D} is produced.

Consider a scenario in which user A transacts with user B. The user A creates and submits Transaction 1: SIG_{A}(Pay x AML tokens from PK′_{A} to PK′_{B}). The system validators verify that PK_{A} has at least x AML tokens. The validators further verify that PK_{A} is certified to transact in AML tokens. The validators further verify that PKB is certified to transact in AML tokens. The validators commit a block containing Transaction 1 to the blockchain 120.

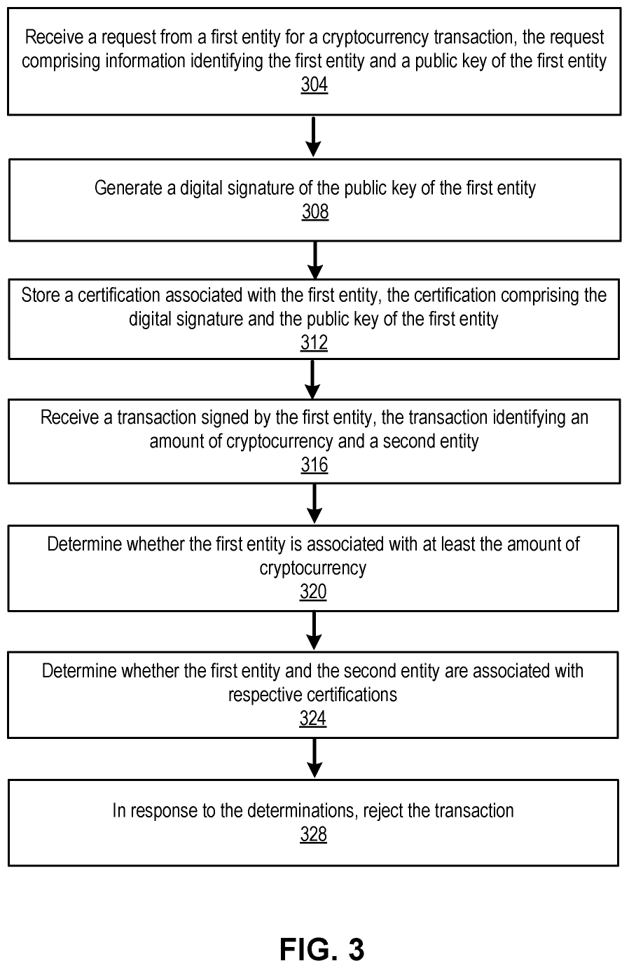

FIG. 3 is a flowchart illustrating a process for auditing digital currency transactions in accordance with one or more embodiments. In some embodiments, the process of FIG. 3 is performed by a certification authority for conducting a transaction between two entities. Other entities perform some or all of the steps of the process in other embodiments. Likewise, embodiments may include different and/or additional steps, or perform the steps in different orders.

A certification authority receives 304 a request from a first entity for a cryptocurrency transaction. The request includes information identifying the first entity and a public key of the first entity. The certification authority generates 308 a digital signature of the public key of the first entity. The certification authority stores 312 a certification associated with the first entity. The certification includes the digital signature and the public key of the first entity.

The certification authority receives 316 a transaction signed by the first entity. The transaction identifies an amount of cryptocurrency and a second entity. The computer device determines 320 whether the first entity is associated with at least the amount of cryptocurrency, though as described above, in some implementations this step is optional. The computer device determines 324 whether the first entity and the second entity are associated with respective certifications. In response to the determinations, the certification authority rejects 328 the transaction (e.g., does not authorize the transaction).

Consider a scenario in which user A transacts with user C. The user A creates and submits a Transaction 2: SIG_{A}(“Pay x AML tokens from PK′_{A} to PK′_{C}.”) The system validators verify that PK_{A} has at least x AML tokens. The validators further verify that PK_{A} is certified to transact in AML tokens. However, the validators reject PK_{C} because this public key is not certified to transact in AML tokens. The validators further reject any block containing Transaction 2 from the blockchain 120 (if such a block were ever proposed).

A process for selective discovery of transaction participants can be performed as follows. An authorized government agency wishes to determine the real-world identities of the participants in Transaction 1. Since Transaction 1 is a payment from PK′_{A} to PK′_{B}, the PK′_{A} is certified by Bank One, and PK′_{B} is certified by Bank Two. The authorized government agency requests and obtains from Bank One the identity of the owner of the public key PK_{A}. The authorized government agency requests and obtains from Bank Two the identity of the owner of PK_{B}.

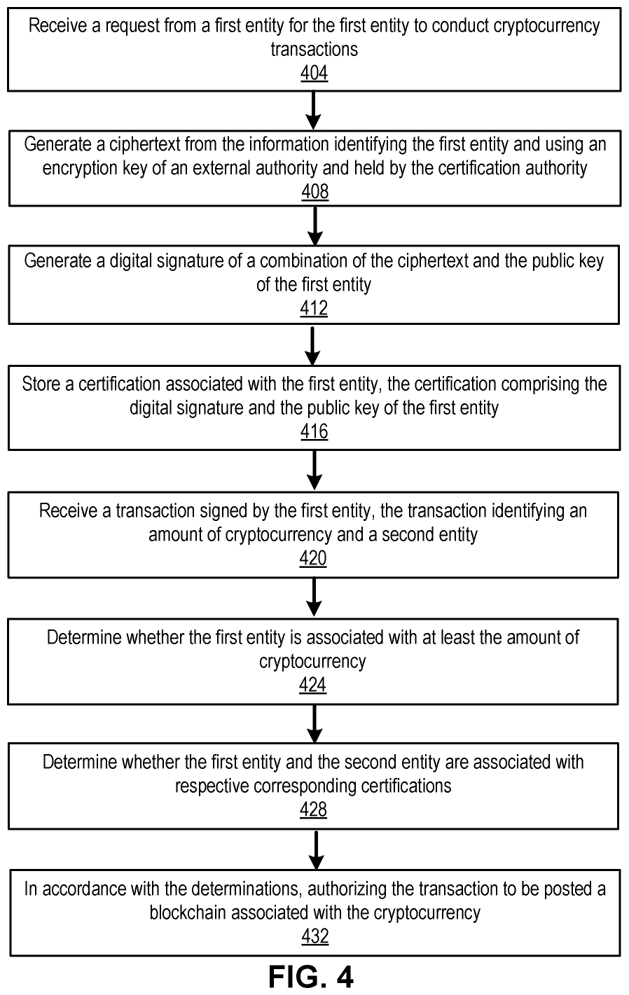

FIG. 4 is a flowchart illustrating a process for auditing digital currency transactions in accordance with one or more embodiments. In some embodiments, the process of FIG. 4 is performed by a certification authority for conducting a transaction between two entities. Other entities perform some or all of the steps of the process in other embodiments. Likewise, embodiments may include different and/or additional steps, or perform the steps in different orders.

A certification authority receives 404 a request from a first entity for the first entity to conduct cryptocurrency transactions. The request includes information identifying the first entity and a public key of the first entity. The certification authority generates 408 a ciphertext from the information identifying the first entity and using an encryption key of an external authority and held by the certification authority. The certification authority generates 412 a digital signature of a combination of the ciphertext and the public key of the first entity. The digital signature is generated using a private key of the certification authority. The certification authority stores 416 a certification associated with the first entity. The certification includes the digital signature and the public key of the first entity.

The certification authority receives 420 a transaction signed by the first entity. The transaction identifies an amount of cryptocurrency and a second entity. The certification authority (optionally) determines 424 whether the first entity is associated with at least the amount of cryptocurrency. The certification authority determines 428 whether the first entity and the second entity are associated with respective corresponding certifications. In accordance with the determinations, the certification authority authorizes 432 the transaction to be posted to a blockchain associated with the cryptocurrency.

In some embodiments, AML, is achieved via direct discovery (sometimes referred to as express discovery) as follows. A public encryption key, E_{Gov}, is selected by an authorized government agency along with a corresponding secret decryption key, D_{Gov}, according to a given public encryption scheme. Accordingly, an entity having knowledge of E_{Gov} can generate a cipher text Encrypt_{EGov}(m) for a message m. Only an entity having knowledge of D_{Gov} can retrieve the original message m from Encrypt_{EGov}(m). Here, PK′ᵤ refers to a certified public key for user u. This Algorand public key is signed by an ABI after user u submits its request for access to AML tokens along with its real-world identification. The expressed certified public key is given in equation (1) as follows.

SIG_{BankOne}(PK_{A}, Encrypt_{EGov}(A)=Expressly Certified public key PK″_{A} (1)

Consider a scenario in which user A registers itself. The user A requests Bank One to transact with AML tokens for PK_{A} after agreeing to all terms and conditions. Bank One securely stores user A's request for AML token access. User A submits its identification to Bank One. Bank One accepts user A for AML token access. Bank One retains user A's identifying information securely. Bank One encrypts user A's identifying information with E_{Gov}, so as to compute the ciphertext A″. Bank One expressly certifies PK_{A} by digitally signing together PK_{A} and A″ as expressed in equation (2)

SIG_{BankOne}(PK_{A}, A″)=Expressly Certified public key PK″_{A} (2)

Consider a scenario in which user B registers itself. The user B registers itself as above with Bank Two, expressed as in equation (3).

SIG_{BankTwo}(PK_{B}, B″)=Expressly certified public key PK″_{B} (3)

Consider a scenario in which user A transacts with user B. The user A creates and submits Transaction 1: SIG_{A}(Pay x AML tokens from PK″_{A} to PK″_{B}). The system validators verify that PK_{A} has at least x AML tokens. The validators further verify that PK_{A} is expressly certified to transact in AML tokens. The validators further verify that PKB is expressly certified to transact in AML tokens. The validators commit the block containing Transaction 1 to the blockchain 120. Further, a direct discovery of transaction participants can be performed as follows. Upon seeing Transaction 1, the authorized government agency immediately identifies its participants as follows. Transaction 1 contains both PK″_{A} and PK″_{B}. PK″_{A} contains Encrypt_{EGov}(A) and PK″_{B} contains Encrypt_{EGov}(B). The government knows D_{Gov} and thus easily decrypts A and B from their ciphertexts without any interactions with Bank One or Bank Two.

In some embodiments, a multi-signature scheme is implemented as follows for key recovery. A public key PK has two signers, an ordinary signer and an emergency signer, each having a separate secret signing key. A user U who registers PK with a bank B is referred to as the ordinary signer and B is referred to as the emergency signer. The digital signatures produced by either signer can be validated relative to the same PK, but those produced by the emergency signer automatically reveal that B is the signer.

Consider a scenario in which user U loses its secret key. Then, user U and the bank B produce a new public key PK′ (for which U is the ordinary signer and B the emergency signer). Further, user U authorizes (e.g., “in writing”) the bank B to transfer all money from PK to PK′. The bank B safekeeps U's authorization. The bank B emergency signs the transfer of the entire balance from PK to PK′. The transaction is valid and is recorded on the blockchain 120. At this point, user U has fully recovered the use of its funds. Note that B cannot rob U's money with impunity. Indeed, B must leave untamperable evidence any time it transfers any amount of U's funds. The same technology can be employed, with governmental consent, to correct an illicit or incorrect transaction of U. This reversal can be made by B, but not without leaving untamperable evidence.

Permissioned Blockchain Transactions

In some embodiments, a permissioned version of the blockchain 120 that balances privacy and traceability is used. The permissioned blockchain 120 enables a new class of incentives and provides a new and non-controlling role for banks or other external entities. This permissioned version uses digital certificates as described below.

Consider a scenario in which a public key pk of a party R that has the authority to register users in the system is publicly known. After identifying a user i and verifying that a public key pkᵢ really belongs to i, R may issue a digital certificate, Cᵢ, guaranteeing that, not only is pki a legitimate public key in the system, but also that some suitable additional information infoᵢ holds about i. In this case, a certificate has essentially the following form as expressed in equation (4).

Cᵢ=SIG_{R}(R, pkᵢ, infoᵢ) (4)

The information specified in infoᵢ may be quite varied. For instance, it may specify i's role in the system and/or the date of issuance of the certificate. It might also specify an expiration date, that is, the date after which one should no longer rely on Cᵢ. If no such a date is specified, then Cᵢ is non-expiring.

In some embodiments, non-expiring certificates are used. Each user i ϵ PK^{r} has digital certificate Cᵢ issued by a suitable entity R (e.g., by a bank in a pre-specified set). When making a round-r payment ϕ to another user j, i may forward Cᵢ and/or Cⱼ along with ϕ or include one or both of them in ϕ itself as in equation (5).

ϕ=SIGᵢ(r, r′, i, j, a, Cᵢ, Cⱼ, I, H(I)) (5)

In some embodiments, a payment ϕ is considered valid at a round, and thus may enter PAY^{r} only if it also includes the certificates of both its payer and its payee. Moreover, if the certificates have expiration dates r=[t₁, t₂], then t₂ must be smaller than the earliest expiration date. At the same time, if such a payment belongs to PAY^{r} then its corresponding money transfer is executed unconditionally.

### Non-Expiring Certificates

Once the certificate Cᵢ of a user i expires, or prior to its expiration, as long as i is “in good standing,” R may issue a new certificate Cᵢ′ with a later expiration date. In this case, therefore, R has significant control over i's money. It cannot confiscate it for its personal use (because doing so would require being able to forge i's digital signature), but it can prevent i from spending it. In fact, in a round r following the expiration date of Cᵢ, no payment of i may enter PAY^{r}. This power of R corresponds to the power of a proper entity E, e.g., the government, to freeze a user's traditional bank account. In fact, in a traditional setting, such E might even appropriate i's money. The benefits and advantages of cryptocurrencies is the difficulty, for any entity E, to separate a user from its money. This difficulty continues to hold in a certificate-based version of Algorand in which all certificates are non-expiring. Indeed, a user i wishing to make a payment to another user j in a round r can always include the non-expiring certificates Cᵢ and Cⱼ in a round-r payment ϕ to j, and ϕ will appear in PAY^{r}, if the leader l^{r} of the round is honest. In sum, non-expiring certificates cannot be used to separate a user from its money, but may actually be very valuable to achieve other goals.

### Preventing Illegal Activities Via (Non-Expiring) Certificates

In some embodiments, a payer and a payee of a payment made via a traditional check are readily identifiable by each entity holding the check. Accordingly, checks are not ideal for money laundering or other illegal activities. Digital certificates, issued by a proper registration agent, could be used in Algorand to ensure that only some given entities can identify the owner i of a given public key pkᵢ, and only under proper circumstances, without preventing i from making the payments it wants. For example, there may be multiple registration authorities in the system. Consider that the authorities are approved banks, whose public keys are universally known (or have been certified, possibly via a certificate chain) by another higher authority whose public key is universally known, and let G be a special entity, referred to as the government.

To join the system as the owner of a digital public key, i needs to obtain a certificate Cᵢ from one of the approved banks. To obtain it, after generating a public-secret signature pair (pkᵢ, skᵢ), i asks an approved bank B to issue a certificate for pkᵢ. In order to issue such a certificate, B is required to identify i, so as to produce some identifying information IDi. Then, B computes H(IDᵢ), and (preferably) makes it a separate field of the certificate. For instance, ignoring additional information, B computes and gives i a certificate as expressed in equation (6).

Cᵢ=SIG_{B}(B, pkᵢ, H(IDᵢ)) (6)

Such IDᵢ can include i's name and address, a picture of i, the digital signature of i's consent—if it was digital—, or i can be photographed together with its signed consent, and the photo digitized for inclusion IDᵢ. For its own protection and that of i as well, the bank may also obtain and keep a signature of i testifying that IDᵢ is indeed correct.

Since H is a random oracle (e.g., a collision-resistant hash function, modeled as a random oracle), no one can recover the owner's identity from Cᵢ. Only the bank knows that pkᵢ's owner is i. However, if the government wishes to investigate, say, the payer of a payment ϕ=SIGₚₖᵢ(r, pkᵢ, pkᵢ′, a, Cᵢ, Cᵢ′, I, H(I)), it retrieves from ϕ both the relevant certificate Cᵢ and the bank B that has issued Cᵢ, and then asks or compels B, with proper authorization (e.g., a court order), to produce the correct identifying information IDᵢ of i. The bank cannot reveal an identifying piece of information ID′ᵢ that is different from that originally inserted in the certificate, because H is collision-resilient. Alternatively, instead of H(IDᵢ), it suffices to use any “commitment” to IDᵢ, in the parlance of cryptography. One particular alternative is to store, in Cᵢ, an encryption of IDᵢ, E(IDᵢ), preferably using a private- or public-key encryption scheme E, that is uniquely decodable. In particular, IDᵢ may be encrypted with a key known only to the bank B: in symbols, E(IDᵢ)=E_{B}(IDᵢ). This way, the government needs B's help to recover the identifying information IDᵢ.

Alternatively, E may be a public-key encryption scheme, and IDᵢ may be encrypted with a public key of the government, who is the only one to know the corresponding decryption key. In symbols, E(IDᵢ)=E_{G}(IDᵢ). In this case the government need not have B's help to recover IDᵢ. In fact, the identities of the payers and the payees of all payments are transparent to G. However, no one else may learn IDᵢ from E_{G}(IDᵢ), besides the government and the bank that has computes E_{G}(IDᵢ) from IDᵢ. Moreover, if the encryption E_{G}(IDᵢ) is probabilistic, then even someone who has correctly guessed who the owner i of pkᵢ is would be unable to confirm its guess. Neither B nor G, once the certificate Cᵢ has been issued, has any control over i's digital signatures, because only i knows the secret key skᵢ corresponding to pkᵢ. In addition, neither B or G can understand the sensitive information (I) of the payment ϕi, because only H(I) is part of ϕ. Finally, neither B nor G is involved in processing the payment ϕ, only the randomly selected verifiers are. Thus, law-enforcement concerns about traditional systems are mitigated without sacrificing the privacy of the users. In fact, except for B and G, i continues to enjoy the same (pseudo) anonymity it enjoys in traditional systems, relative to anyone else: banks, merchants, users, etc. Finally, by using more sophisticated cryptographic techniques, it is also possible to increase user privacy while maintaining traceability under the appropriate circumstances. For example, once i has obtained from bank B a certificate Cᵢ=SIG_{B}(B, pkᵢ, E_{G}(IDᵢ)), it is also possible for i to obtain another certificate C′ᵢ=SIG_{B}(B, pkᵢ, E_{G}(IDᵢ)), for a different public pkᵢ, for which B no longer knows that IDᵢ is the decryption of E′_{G}(IDᵢ).

In some embodiments, key certification is performed by the banks for customers. By certifying a key i of one of its customers, bank B performs a simple but valuable (and possibly financially rewarded) service. Another role a bank B may have in Algorand is that, properly authorized by a customer i, B can transfer money from i's traditional bank accounts to a digital key: the digital pkᵢ that i owns in Algorand. (In fact, B and all other banks do so “at the same exchange rate,” Algorand may be used as a very distributed, convenient, and self-regulated payment system, based on a national currency.) One way for a bank B to transfer money to pkᵢ is to make a payment to pkᵢ from a digital key pk_{B} that B owns in Algorand. In fact, banks may, more easily than their customers, convert national currency into Algorand at a public exchange. Going a step further, the Government may also be allowed to print money in Algorand, and may transfer it, in particular, to banks, or, if the banks are sufficiently regulated, it may allow them to generate Algorand money within certain parameters. Finally, since banks are often trusted, a user i, retaining full control of the payments he makes, may wish to delegate a bank B to act on his behalf as a verifier, sharing with B his verification incentives.

Whether or not the registration authorities are banks, and whether or not law-enforcement concerns are addressed, a permissioned deployment of Algorand enables one to identify (e.g., within its certificate Cᵢ) that a given key pkᵢ belongs to a merchant. For example, a merchant, that currently accepts credit card payments, has already accepted his having to pay transaction fees to the credit card companies. Thus, it may prefer paying a 1% fee in Algorand than paying the typically higher transaction fee in a credit card system (in addition to preferring to be paid within minutes, rather than days, and in much less disputable ways.) Accordingly, a certificate-based Algorand may ensure that (1) Algorand rewards a small percentage of the payments made to merchants only, and yet (2) the verifiers are incentivized to process all other payments as well.

For instance, letting A′ be the total amount paid to retailers in the payments of PAY^{r}, a maximum potential reward R′ (e.g., R′=1% A′) can be computed. The leader and the verifiers, however, will not collectively receive the entire amount R′, but only a fraction of R′ that grows with the total number (or the total amount, or a combination thereof) of all payments in PAY^{r}. For example, keeping things very simple, if the total number of payments in PAY^{r} is m, then the actual reward that will be distributed will be R′(1−1/m). As before, this can be done automatically by deducting a fraction 1%(1−1/m) from the amount paid to each retailer, and partitioning this deducted amount among the leader and verifiers according to a chosen formula.

Parameterized Auditability and Balancing Transaction Anonymity with Compliance

Transaction traceability is achieved in Algorand blockchain-based system because all transfers are attributed to public keys of the sources and destinations. Therefore, any asset on the Algorand blockchain, such as a CBDC, being exchanged has clear provenance. A public key serves as a proxy identity, but may not be sufficient by itself to establish a connection to the real world individual or organization behind that key as may be required in order to comply with regulations. Registering a public key with an identity provider to certify the real-world identity bridges this gap.

The Algorand blockchain can implement parameterized auditability based on digital certificates and may register public keys to real-world identities with identity providers. In order to balance end-user anonymity with compliance and regulatory requirements, we propose a three-tier parameterized system that an agency, such as a central bank with a central bank digital currency (CDBC), can adjust to their exact needs. A Public Key must be properly registered to participate in a transaction of the first two tiers. As we shall see, the registration process will enable the Central Bank to trace the real-world individuals behind the registered keys.

In some embodiments, three tiers are used. For example, Tier 1 refers to high-value immediate-reveal transactions (direct discovery). A transaction is in Tier 1 if its monetary value exceeds a chosen high-value parameter, for example $10,000. Only Tier-1-registered keys can engage in Tier-1 transactions. Our registration technology ensures that the real-world IDs of the owners of a Tier-1 key are available to the central bank in the most direct manner.

Tier 2 refers to medium-value interactive-reveal transactions (assisted discovery). A transaction is in Tier 2 if its monetary value is between the chosen high threshold and a new, low threshold parameter, for example $100 dollars. Only Tier-1 or Tier-2 registered keys can engage in tier-2 transactions. The registration technology ensures that the real-world IDs of the owners of a Tier-2 key are available to the central bank via interaction with an identity provider. As described below, a privacy-valuing user will not use a Tier-1 key to make Tier-2 transactions, although it has the ability to do so.

Tier 3 refers to low-value high-anonymity transactions (statistical discovery). A transaction is in this tier if its monetary value is less than the chosen low threshold. Tier-3 registered keys are capable of making low-value transactions, but the registration of such keys will not enable the central bank to discover the identity of the real-world individuals behind the keys. The central bank will have to resort to statistical analysis of the transactions of a given key to understand who the real-world individual behind the key may be. If this tier of anonymous transactions is not desirable, then the central bank can set the low threshold to 0.

Tier-1 and Tier-2 keys can also make Tier-3 transactions. Again, however, privacy-valuing users will not want to use a Tier-1 or Tier-2 keys to make a low-value transaction.

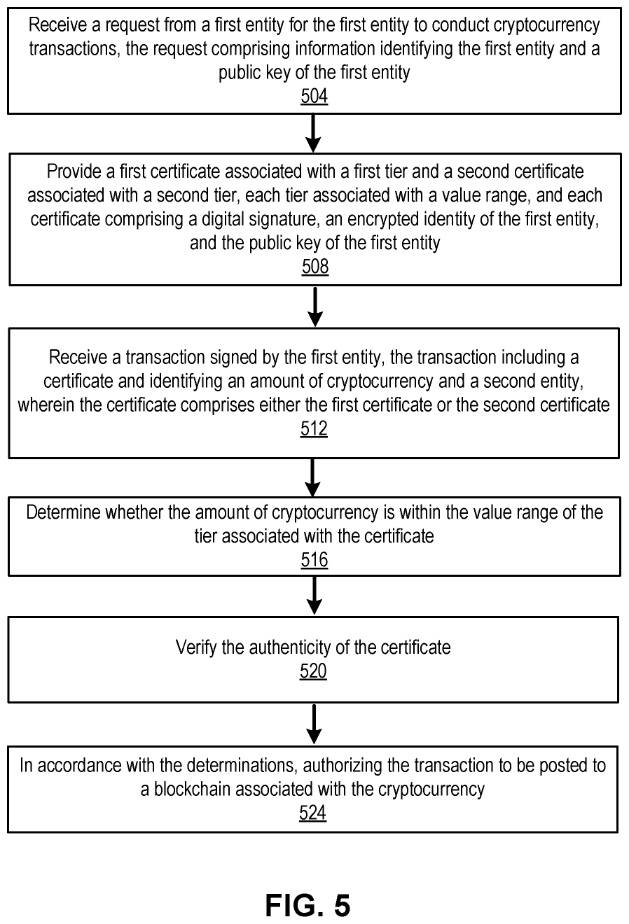

FIG. 5 is a flowchart illustrating a process for auditing digital currency transactions in accordance with one or more embodiments. In some embodiments, the process of FIG. 5 is performed by an identity provider for conducting a transaction between two entities. Other entities perform some or all of the steps of the process in other embodiments. Likewise, embodiments may include different and/or additional steps, or perform the steps in different orders.

A computer device (e.g., of the identity provider) receives 504 a request from a first entity for the first entity to conduct cryptocurrency transactions. The request includes information identifying the first entity and a public key of the first entity. The identity provider provides 508 a first certificate associated with a first tier and a second certificate associated with a second tier. Each tier is associated with a value range. Each certificate includes a digital signature, an encrypted identity of the first entity, and the public key of the first entity.

A computer device (which may be associated with the identity provider or may be associated by an entity other than the identity provider) receives 512 a transaction signed by the first entity. The transaction includes a certificate and identifies an amount of cryptocurrency and a second entity. The certificate includes either the first certificate or the second certificate. Optionally, a computer device determines 516 whether the amount of cryptocurrency is within the value range of the tier associated with the certificate. A computer device 520 verifies the authenticity of the certificate. In accordance with the determinations, a computer device authorizes 524 the transaction to be posted to a blockchain associated with the cryptocurrency.

### Key Registration

To register a public key PK it has chosen (together with a matching secret signing key), an end-user first passes a know your customer (KYC) process using with an identity provider (IP). Second, it gives PK to the IP, specifying the desired tier T for PK. In turn, it receives from IP a digital tier-T certificate for PK. The end-user is able to request any number of Tier-1 and Tier-2 keys. There is a limit, however, on the number of Tier-3 keys that the identity provider can certify to the same individual, in order to prevent bypassing system safeguards.

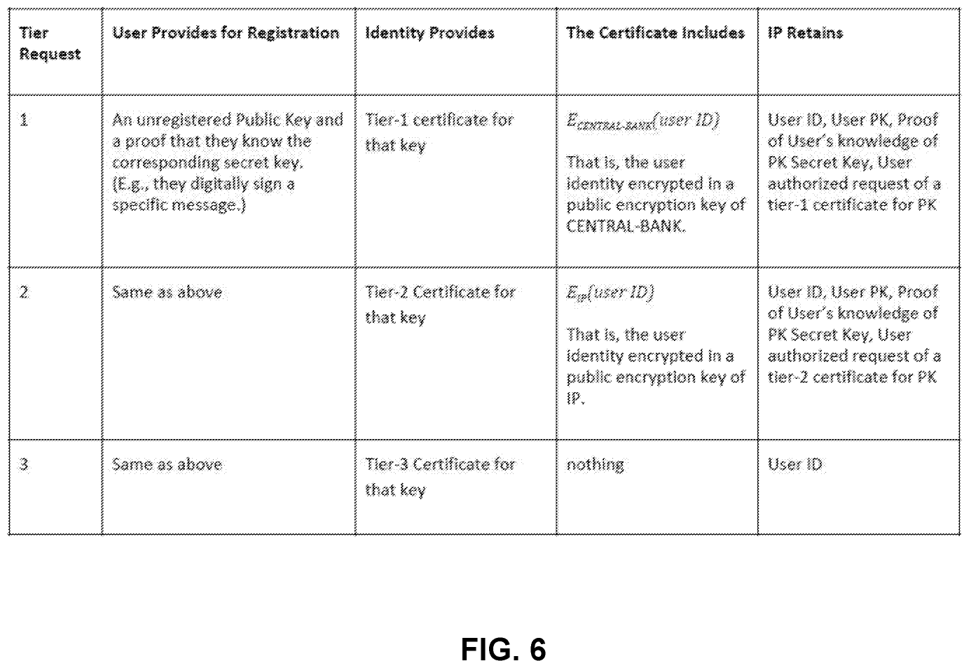

FIG. 6 illustrates a table describing what the end-user gets for each tier of key. A tier-T certificate includes a digital signature of an identity provider securely binding together: (1) the certified public key, (2) the tier level, (3) the encrypted user ID (for the first two tiers only) and (4) any desired additional information, such at the start time and expiration time of the certificate. For example, a tier-1 certificate has the form as in in expression (7).

SIG_{IP}(PK, 1, E_{CENTRAL-BANK}(user ID), info) (7)

A Tier-2 certificate has the form as in expression (8).

SIG_{IP}(PK, 2, E_{IP}(user ID), info) (8)

A Tier-3 certificate has the form as in expression (9).

SIG_{IP}(PK, 3, null, info) (9)

Tier-3 certificates are used even though no ID information of Tier-3 owners is retained by identity providers in order to prevent end-users from making numerous Tier-3 public keys and, thereby, bypassing system imposed limits.

A user can have multiple Tier-1, Tier-2, and Tier-3 certified keys, if it so wants. And it chooses which key to transact, depending on the monetary value of the transaction and the level of privacy it wants to keep. If the user wishes to engage in a high-value transaction, such as purchasing a car, it must use a Tier-1 key, knowing that her identity is directly available to the central bank. If the user wants to engage in a Tier-2 transaction, it can either use a Tier-1 key or a Tier-2 key, in its possession. However, it may prefer to use a Tier-2 key for Tier-2 transactions. This is so, because middle-value transactions are more frequent than high-value ones. Thus, by using a Tier-1 key for medium-level transactions, it will give the central bank a lot of information about its spending habits. An Algorand implemented software wallet will not use a higher-tier key for a lower-tier transaction, if the right-tier key is available. But, if the central bank so wants, it can force Tier-T keys to be used for Tier-T transactions. While the user may be given the ability to use a higher-tier key for a lower-tier transaction, the opposite is not true. Specifically, the system ensures that only Tier-T keys are capable of conducting transactions of Tier-T and below. By doing so the system guarantees the right level of auditability of every transaction. Furthermore, a transaction in the Algorand blockchain is valid only if the paying key possesses enough of the specified currency.

Transaction Identity Discovery is performed as follows. Direct Discovery: for Tier-1 transactions, discovery by the central bank is easy and automatic. Every such transaction will contain the encrypted real-world ID of the sender and receiver, so the central bank can decrypt it at its leisure and does not need to involve any other party such as that identity provider. Assisted Discovery: for Tier-2 transactions, discovery is interactive. The central bank must request the identity provider associated with the transaction to reveal the real-world IDs of the sender and receiver for that particular transaction. Statistical Discovery: for Tier-3 transactions, discovery is statistical in nature. That is, the central bank can only determine the historical use of a Tier 3 Public Key. It may be that that analysis is sufficient to reveal aspects of the real world user who owns that key.

The abuse of Tier-3 keys can be prevented as follows. The existence of Tier-3 keys is an option that the central bank has and may indeed choose not to exercise this option. Tier-3 keys may actually be valuable for users such as migrant workers who do not have proper identification documents. However, Tier-3 keys can be abused to avoid the traceability guaranteed by Tier-1 and Tier-2 keys. For instance, to prevent the central bank from learning about a $10,000 payment to a given key X, a malicious user can use his Tier-1 key to make a hundred transfers of a hundred dollars each to a hundred different tier-3 keys, and then have all these hundred tier-3 keys transfer all they have to key X. To prevent that abuse while maintaining the use of tier-3 keys, the following mechanism can be used for registering tier-3 keys. Namely to obtain a tier-3 key, a user makes a payment to an IP of $X dollars where X is less than 100, passes KYC, and then is given by the IP a tier-3 key with the amount of X. Because physical interaction is needed with key registration it requires time and resources, therefore, gathering numerous tier-3 keys will be very difficult. Additionally these tier-3 keys can be made as spend only, further limiting abuses to the auditing system.

In some embodiments, symmetric key encryption for assisted discovery is used. Assume Bank B does KYC for a public key PK, whose owner is ID. Then, B provides ID with SIG_{B}(PK, E_{B}(ID)) and E_{B}(ID), where E_{B}(ID) is an encryption of ID with a key of B. To be valid and posted on the Algorand blockchain, any payment from PK for an amount above t dollars must openly include in one of its fields B, SIG_{B}(PK, E_{B}(ID)) and E_{B}(ID). The presence of these two pieces of information guarantee that (1) B has conducted KYC for the owner of PK and can reveal ID upon a proper request (e.g., a court order), (2) no one besides Bank B and a proper agency of the Government may learn the identity of the owner of PK, and (3) the proper AML authority may learn ID from B if necessary.

In some embodiments, public key encryption for direct discovery is performed. These embodiments are based on public-key encryption, and offer greater and simpler AML guarantees, and makes sense for payments of high amounts, that is, above $T. In a public-key encryption system, a user X generates two separate keys: an encryption key PK_{X} and a matching decryption key SK_{X}. Key PK_{X} is used to encrypt messages, and SK_{X} to decrypt the messages encrypted with PK_{X}. Anyone can use PK_{X} to create an encryption E_{X}(m) of any message m, but E-X(m) can be decrypted only by one who knows SK_{X}. Moreover, the two keys do not betray each other. That is, knowledge of PK_{X} does not help anyone to figure out SK_{X}. Thus, it is in the interest of X to make PK_{X} public, so as to enable anyone to send X an encrypted message, but to keep SK_{X} secret, so as to prevent anyone else from understanding the messages sent to X in encrypted form. Accordingly, PK_{X} is often referred to as X's public key and SK_{X} as X's secret key.

During KYC, ID may provide Bank B a signature key PK′ and receive from B both the signature SIG_{B}(PK′, E_{GOV}(ID)) and the encryption E_{GOV}(ID). Here E_{GOV}(ID) is an encryption of ID with the public encryption key of a proper agency of the Government. To be valid and postable on the Algorand blockchain, any payment of PK′ for more than T dollars, must include both SIG-B(PK′, E_{GOV}(ID)) and E_{GOV}(ID). Thus, the Government agency (who knows the secret key corresponding to its own public key) can directly understand that the owner of PK′ is ID, without any time-consuming requests to bank B. On the other side, no one will be able to figure out from SIG-B(PK, E-_{GOV}(ID)) and E_{GOV}(ID) that the owner of PK′ is ID, except for the bank B that has performed the KYC. This direct visibility of ID to a proper Government agency does not violate any privacy, if the law requires that any payment above T dollars must be reported to the proper authority.

### Machine Implementation of Auditing Digital Currency Transactions

FIG. 5 illustrates an example machine. In the implementation of FIG. 5, the computer system 700 is a special purpose computing device. The special-purpose computing device is hard-wired to perform multi-party cryptographic transactions, or includes digital electronic devices such as one or more application-specific integrated circuits (ASICs) or field programmable gate arrays (FPGAs) that are persistently programmed to perform the techniques herein, or include one or more general purpose hardware processors programmed to perform the techniques pursuant to program instructions in firmware, memory, other storage, or a combination. In various implementations, the special-purpose computing devices are desktop computer systems, portable computer systems, handheld devices, network devices or any other device that incorporates both hard-wired or program logic to implement the techniques.

The computer system 700 includes a bus 702 or other communication mechanism for communicating information, and one or more computer hardware processors 704 coupled to the bus 702 for processing information. In some implementations, the hardware processors 704 are general-purpose microprocessors. The computer system 700 also includes a main memory 706, such as a random-access memory (RAM) or other dynamic storage device, coupled to the bus 702 for storing information and instructions to be executed by processors 704. In one implementation, the main memory 706 is used for storing temporary variables or other intermediate information during execution of instructions to be executed by the processors 704. Such instructions, when stored in non-transitory storage media accessible to the processors 704, render the computer system 700 into a special-purpose machine customized to perform the operations specified in the instructions.

In an implementation, the computer system 700 further includes a read only memory (ROM) 708 or other static storage device coupled to the bus 702 for storing static information and instructions for the processors 704. A storage device 712, such as a magnetic disk, optical disk, solid-state drive, or three-dimensional cross point memory is provided and coupled to the bus 702 for storing information and instructions.

In an implementation, the computer system 700 is coupled via the bus 702 to a display 724, such as a cathode ray tube (CRT), a liquid crystal display (LCD), plasma display, light emitting diode (LED) display, or an organic light emitting diode (OLED) display for displaying information to a computer user. An input device 714, including alphanumeric and other keys, is coupled to bus 702 for communicating information and command selections to the processors 704. Another type of user input device is a cursor controller 716, such as a mouse, a trackball, a touch-enabled display, or cursor direction keys for communicating direction information and command selections to the processors 704 and for controlling cursor movement on the display 724.

According to one implementation, the techniques herein are performed by the computer system 700 in response to the processors 704 executing one or more sequences of one or more instructions contained in the main memory 706. Such instructions are read into the main memory 706 from another storage medium, such as the storage device 712. Execution of the sequences of instructions contained in the main memory 706 causes the processors 704 to perform the process steps described herein. In alternative implementations, hard-wired circuitry is used in place of or in combination with software instructions.

The term “storage media” as used herein refers to any non-transitory media that store both data or instructions that cause a machine to operate in a specific fashion. Such storage media includes both non-volatile media or volatile media. Non-volatile media includes, such as optical disks, magnetic disks, solid-state drives, or three-dimensional cross point memory, such as the storage device 712. Common forms of storage media include, such as a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge. Storage media is distinct from but is used in conjunction with transmission media. Transmission media participates in transferring information between storage media. Transmission media includes coaxial cables, copper wire and fiber optics, including the wires that include the bus 702.

In an implementation, various forms of media are involved in carrying one or more sequences of one or more instructions to the processors 704 for execution. The instructions are initially carried on a magnetic disk or solid-state drive of a remote computer. The remote computer loads the instructions into its dynamic memory and send the instructions over a telephone line using a modem. A modem local to the computer system 700 receives the data on the telephone line and use an infrared transmitter to convert the data to an infrared signal. An infrared detector receives the data carried in the infrared signal and appropriate circuitry places the data on the bus 702. The bus 702 carries the data to the main memory 706, from which processors 704 retrieves and executes the instructions. The instructions received by the main memory 706 are optionally stored on the storage device 712 either before or after execution by processors 704.

The computer system 700 also includes a communication interface 718 coupled to the bus 702. The communication interface 718 provides a two-way data communication coupling to a network link 720 connected to a local network 722. The communication interface 718 is an integrated service digital network (ISDN) card, cable modem, satellite modem, or a modem to provide a data communication connection to a corresponding type of telephone line. In another implementation, the communication interface 718 is a local area network (LAN) card to provide a data communication connection to a compatible LAN. In some implementations, wireless links are also implemented.

The network link 720 typically provides data communication through one or more networks to other data devices. The network link 720 provides a connection through the local network 722 to a host computer 724 or to a cloud data center or equipment operated by an Internet Service Provider (ISP) 726. The ISP 726 in turn provides data communication services through the world-wide packet data communication network now commonly referred to as the “Internet” 728. The local network 722 and Internet 728 both use electrical, electromagnetic or optical signals that carry digital data streams.

Unless contrary to physical possibility, it is envisioned that (i) the methods/steps described herein may be performed in any sequence and/or in any combination, and that (ii) the components of respective embodiments may be combined in any manner. The machine-implemented operations described above can be implemented by programmable circuitry programmed/configured by software and/or firmware, or entirely by special-purpose (“hardwired”) circuitry, or by a combination of such forms. Such special-purpose circuitry (if any) can be in the form of, for example, one or more application-specific integrated circuits (ASICs), programmable logic devices (PLDs), field-programmable gate arrays (FPGAs), system-on-a-chip systems (SOCs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., RANI or ROM; magnetic disk storage media; optical storage media; flash memory devices; etc.), etc.

The term “logic”, as used herein, means: i) special-purpose hardwired circuitry, such as one or more application-specific integrated circuits (ASICs), programmable logic devices (PLDs), field programmable gate arrays (FPGAs), or other similar device(s); ii) programmable circuitry programmed with software and/or firmware, such as one or more programmed general-purpose microprocessors, digital signal processors (DSPs) and/or microcontrollers, system-on-a-chip systems (SOCs), or other similar device(s); or iii) a combination of the forms mentioned in i) and ii).

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and that (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

In the foregoing description, embodiments have been described with reference to numerous specific details that may vary from implementation to implementation. The description and drawings are, accordingly, to be regarded in an illustrative rather than a restrictive sense. The sole and exclusive indicator of the scope of the embodiments, and what is intended by the applicants to be the scope of the embodiments, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further including,” in the foregoing description or following claims, what follows this phrase can be an additional step or entity, or a sub-step/sub-entity of a previously-recited step or entity.

What is claimed is:

1. A method performed by one or more computer devices associated with a certification authority, the method comprising:
receiving a request from a first entity for the first entity to conduct cryptocurrency transactions, the request comprising information identifying the first entity and a public key of the first entity;
generating a digital signature of the public key of the first entity, the digital signature generated using a private key of the certification authority;
storing a certification associated with the first entity, the certification comprising the digital signature and the public key of the first entity;
at a later time, receiving a transaction signed by the first entity, the transaction identifying an amount of cryptocurrency and a second entity;
determining whether the first entity is associated with at least the amount of cryptocurrency;
determining whether the first entity and the second entity are associated with respective corresponding certifications; and
in accordance with the determinations, authorizing the transaction to be posted to a blockchain associated with the cryptocurrency.

2. The method of claim 1, further comprising:
receiving a request from a second entity for the second entity to conduct cryptocurrency transactions, the request comprising information identifying the second entity and a public key of the second entity;
generating a digital signature of the public key of the second entity; and
storing a certification associated with the second entity, the certification comprising the digital signature and the public key of the second entity.

3. A method performed by one or more computer devices associated with a certification authority, the method comprising:
receiving a request from a first entity for the first entity to conduct cryptocurrency transactions, the request comprising information identifying the first entity and a public key of the first entity;
generating a digital signature of the public key of the first entity, the digital signature generated using a private key of the certification authority;
storing a certification associated with the first entity, the certification comprising the digital signature and the public key of the first entity;
at a later time, receiving a transaction signed by the first entity, the transaction identifying an amount of cryptocurrency and a second entity;
determining whether the first entity is associated with at least the amount of cryptocurrency;
determining whether the first entity and the second entity are associated with respective corresponding certifications; and
in response to the determinations, rejecting the transaction.

4. A method performed by one or more computer devices associated with a certification authority, the method comprising:
receiving a request from a first entity for the first entity to conduct cryptocurrency transactions, the request comprising information identifying the first entity and a public key of the first entity;
generating a ciphertext from the information identifying the first entity and using an encryption key of an external authority and held by the certification authority;
generating a digital signature of a combination of the ciphertext and the public key of the first entity, the digital signature generated using a private key of the certification authority;
storing a certification associated with the first entity, the certification comprising the digital signature and the public key of the first entity;
at a later time, receiving a transaction signed by the first entity, the transaction identifying an amount of cryptocurrency and a second entity;
determining whether the first entity is associated with at least the amount of cryptocurrency;
determining whether the first entity and the second entity are associated with respective corresponding certifications; and
in accordance with the determinations, authorizing the transaction to be posted to a blockchain associated with the cryptocurrency.

5. A method performed by an identity provider comprising:
receiving a request from a first entity for the first entity to conduct cryptocurrency transactions, the request comprising information identifying the first entity and a public key of the first entity;
providing a first certificate associated with a first tier and a second certificate associated with a second tier, each tier associated with a value range, and each certificate comprising a digital signature, an encrypted identity of the first entity, and the public key of the first entity;
receiving a transaction signed by the first entity, the transaction including a certificate and identifying an amount of cryptocurrency and a second entity, wherein the certificate comprises either the first certificate or the second certificate;
determining whether the amount of cryptocurrency is within the value range of the tier associated with the certificate;
verifying the authenticity of the certificate; and
in accordance with the determinations, authorizing the transaction to be posted to a blockchain associated with the cryptocurrency.

6. The method of claim 5, further comprising providing to the first entity, a third certificate associated with a third tier, the third tier associated with a value range, and the third certificate comprising a digital signature and the public key of the first entity.

7. The method of claim 5, wherein the encrypted identity associated with the first certificate is encrypted using an encryption key of an external authority and held by the identity provider.

8. The method of claim 5, wherein the encrypted identity associated with the second certificate is encrypted using an encryption key of the identity provider.
